(19) United States
(12) Patent Application Publication
(10) Pub. No.: US 2005/0086248 A1
(43) Pub. Date: Apr. 21, 2005

(54) Issue tracking

(76) Inventor: Charles Atchison, Alpharetta, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/687,332

(22) Filed: Oct. 16, 2003

(51) Int. Cl. G06F 17/00

(52) U.S. Cl. 707/102

(57) ABSTRACT

An issue tracking system is provided. The system typically includes a centralized server operable to transmit a graphical user interface for tracking project issues over a network, and a database associated with the centralized server provides the graphical user interface to the centralized server. The database also tracks issues related to a topic, provides access through the centralized server to multiple users responsible for resolving issues related to the topic, and provides a storage option for a user to upload data formats which the user determines would be inefficient to manually enter using a graphical user interface format. Methods and other systems are also provided.

### TECHNICAL FIELD

The present disclosure is generally related to project management and more particularly to tracking an issue to a resolution.

### DESCRIPTION OF THE RELATED ART

Worker productivity has increased greatly over the past decade. This increased productivity is due in large part to the widespread use of computers in business. However, continued increases in productivity would not be possible without innovation in the tools and applications that facilitate the use of computers in business applications.

One such application is Microsoft Project available from Microsoft, Corp. of Redmond, Wash. Microsoft project enables project managers to manage several projects at a time through scheduling and resource tools. These tools enable project managers to quickly and easily familiarize themselves with a project, though it may have been a substantial period of time since the project manager last reviewed the project. There are also other project management software applications which are available to help with project management. However, each of these applications tend to require installation of the software at every computer, can result in users having out of date information on a project, and require conversion of existing data to the present format. Therefore, there is a need for addressing these and/or other perceived shortcomings of prior systems.

### SUMMARY

One embodiment, among others, of the present disclosure provides for an issue tracking system. A representative system, among others, includes a centralized server operable to transmit a graphical user interface for tracking project issues over a network, and a database associated with the centralized server provides the graphical user interface to the centralized server. The database also tracks issues related to a topic, provides access through the centralized server to multiple users responsible for resolving issues related to the topic, and provides storage option for a user to upload data formats that the user determines would be inefficient manually enter using a graphical user interface format.

One embodiment, among others, of the present disclosure provides methods for tracking project issues. A representative method, among others, can include the following steps: storing a project in a standardized format on a centralized database; adding an issue associated with the project to the centralized database; enabling users to add at least one step taken to resolve the issue to the centralized database; and, providing an option to a user to upload a data file which is in a data format which the user determines would be inefficient to convert to the standardized format.

Other systems, methods, and/or computer programs products according to embodiments will be or become apparent to one with skill in the art upon review of the following drawings and detailed description. It is intended that all such additional system, methods, and/or computer program products be included within this description, and be within the scope of the present disclosure.

### BRIEF DESCRIPTION OF THE DRAWINGS

The disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram illustrating a network environment in which an embodiment, among others, of the present disclosure can operate.

FIG. 2 is a screen shot of an embodiment, among others, of an opening screen representation of the web interface provided to users in FIG. 1.

FIG. 3 is a screen shot of an embodiment, among others, of a topics viewing screen representation of the web interface provided to users in FIG. 1.

FIG. 4 is a screen shot of an embodiment, among others, illustrating a mouse over feature of the web interface provided to users in FIG. 1.

FIG. 5 is a screen shot of an embodiment, among others, illustrating an item listing for a topic using the web interface provided to users in FIG. 1.

FIG. 6 is a screen shot of an embodiment, among others, illustrating an item detail screen representation of the web interface provided to users in FIG. 1.

FIG. 7 is a screen shot of an embodiment, among others, illustrating an error screen representation of the web interface provided to users in FIG. 1.

FIG. 8 is a screen shot of an embodiment, among others, illustrating an item edit screen representation of the web interface provided to users in FIG. 1.

FIG. 9 is a screen shot of an embodiment, among others, illustrating an add item screen representation of the web interface provided to users in FIG. 1.

FIG. 10 is a screen shot of an embodiment, among others, illustrating an add step screen representation of the web interface provided to users in FIG. 1.

FIG. 11 is a screen shot of an embodiment, among others, illustrating a closed item topic selection screen representation of the web interface provided to users in FIG. 1.

FIG. 12 is a screen shot of an embodiment, among others, illustrating a closed item listing screen representation of the web interface provided to users in FIG. 1.

FIG. 13 is a screen shot of an embodiment, among others, illustrating a test director screen representation of the web interface provided to users in FIG. 1.

FIG. 14 is a screen shot of an embodiment, among others, illustrating a search screen representation of the web interface provided to users in FIG. 1.

FIG. 15 is a screen shot of an embodiment, among others, illustrating a search results screen representation of the web interface provided to users in FIG. 1.

FIG. 16 is a screen shot of an embodiment, among others, illustrating an administrator login screen representation of the web interface provided to users in FIG. 1.

FIG. 17 is a screen shot of an embodiment, among others, illustrating a login confirmation screen representation of the web interface provided to users in FIG. 1.

FIG. 18 is a screen shot of an embodiment, among others, illustrating an administrator screen representation of the web interface provided to users in FIG. 1.

FIG. 19 is a screen shot of an embodiment, among others, illustrating an add topic screen representation of the web interface provided to users in FIG. 1.

FIG. 20 is a screen shot illustrating an embodiment, among others, of the architecture of the database of FIG. 1.

FIG. 21 is a table illustrating an embodiment, among others, of the structure of the items table of FIG. 20.

FIG. 22 is a table illustrating an embodiment, among others, of the structure of the steps table of FIG. 20.

FIG. 23 is a table illustrating an embodiment, among others, of the structure of the topics table of FIG. 20.

### DETAILED DESCRIPTION

The disclosure now will be described more fully with reference to the accompanying drawings. The disclosure may, however, be embodied in many different forms and should not be construed as limited to the embodiments set forth herein; rather, these embodiments are intended to convey the scope of the disclosure to those skilled in the art. Furthermore, all “examples” given herein are intended to be non-limiting.

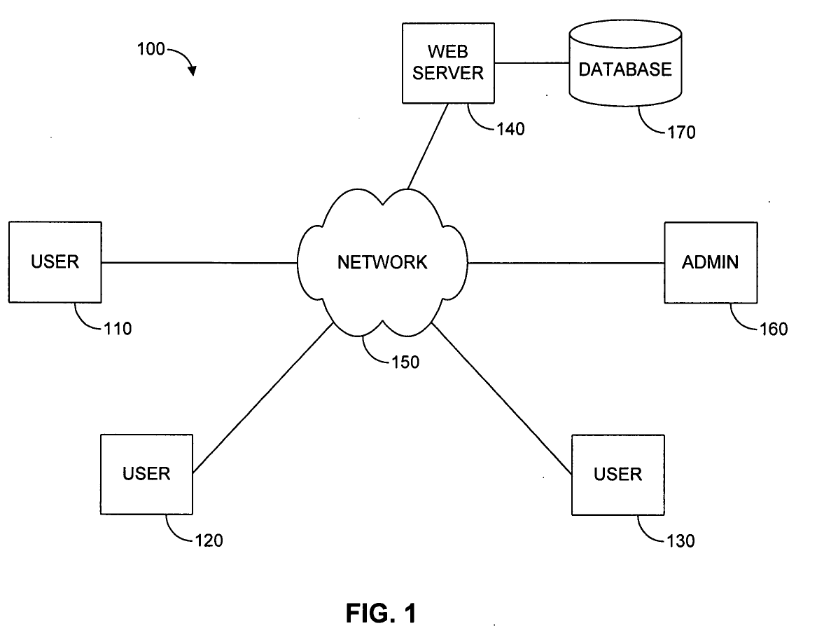

Referring to FIG. 1, shown is a block diagram illustrating a system 100 in which an embodiment, among others, of the present disclosure can operate. In this system 100, each of a plurality of user computers 110, 120, 130 can access a web server 140 through a network 150. Typically, each of the computers 110, 120, 130 have a web browser which typically enables the computers 110, 120, 130 to interpret and view such documents including, among others: hypertext markup language (HTML), standard generalized markup language (SGML), extensible markup language (XML) that is transmitted across the network 150. As known in the art, these languages instruct the receiving computer on how to handle and display files of various types.

Typically, a website is operated by an administrator through his or her computer 160, which is shown in this embodiment, among others, to be remotely located with respect to the web server 140. However, one skilled in the art should recognize that the administrator could operate his or her own web server 140, in which case, there is no need to operate through a remote computer 160. The administrator typically creates a number of files, each of which correspond to a different page of the website. These files are then typically stored on a database 170 connected to the web server 140.

When a user at a remote computer 110 requests a file from the web server 140 over the network 150, such as the internet, for example, he or she typically enters a universal resource locator (URL). The URL is typically mapped to an internet protocol (IP) address by a domain name server (DNS) (not shown). The IP address is typically the unique address for the web server 140 on the internet. The URL can also include a path to the particular file (web page) on the computer which the user wishes to view. One skilled in the art should recognize that the web server 140 may also be set up to send a pre-defined front page to the user upon a receiving a request without a particular file (web page) identified.

As known to those skilled in the art, web pages can come in a variety of forms. Web pages are sometimes classified as passive or active. Passive web pages typically only communicate information to a user making a request for the page. Active web pages typically request information from the user, such as, for example, e-commerce websites which require name, address, and payment information, among others, before processing an order. Many web pages can also be a combination of passive and active.

Further, each of the files comprising a website will also contain a link to one another, such that users can navigate the website easily. These links are typically called hyperlinks. The hyperlink typically includes the URL along with a reference to the specific file (web page) linked. Moreover, there can be links to many different pages included within a single web page. In this way the web page can be set up in a parallel manner such that every page is accessible from a single page. A web page may also be set up serially (daisy-chained) such that a user must view successive pages in order to reach a particular page. These different structures give wide latitude to website designers in planning website use and navigation. One skilled in the art should recognize that an intranet could be used in place of the internet for secure communication of sensitive information.

In the context of an embodiment, among others, of the present disclosure, the website could include a plurality of pages comprising an issue tracking system. The issue tracking system could thus be centrally located to reduce to problems associated with a distributed system (e.g. multiple copies, changes, etc.). Moreover, the issue tracking system could be implemented so as to notify all responsible parties via e-mail when an issue (also referred to herein as an item) has been created, a step toward resolution has been entered, or the issue has been closed.

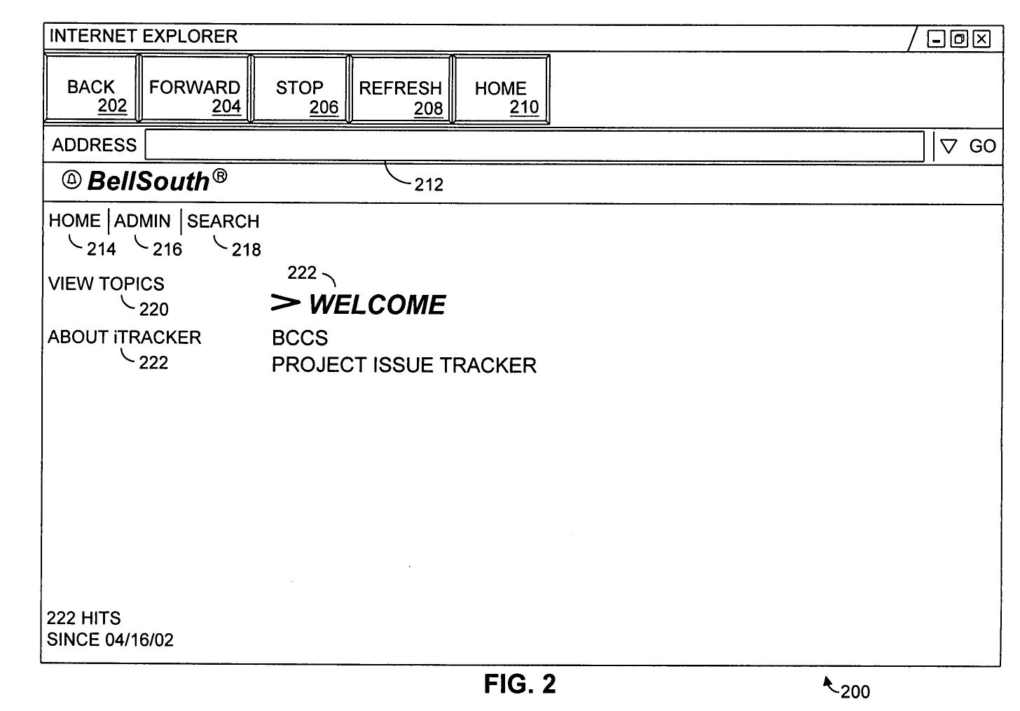

Referring now to FIG. 2, shown is a sample screen shot of an embodiment, among others, of the opening screen representation 200 of the issue tracking system. One skilled in the art should recognize that the window representation is a basic representation of an example of a browser, among other acceptable examples, from Internet Explorer, available from Microsoft, Corp. of Redmond, Wash. Internet Explorer is a software application for viewing html content, typically over the internet, also referred to as a web browser. The web browser typically includes a number of button representations 202, 204, 206, 208, 210 which typically communicate commands to the local computer 110 (FIG. 1), which may in turn send a request to a web server 140 (FIG. 1) based on the command received. For example, the “Back” button representation 202 typically commands the computer to return a web page that is below the current web page on a stack of URLs that have been visited during the current session. Similarly, the “Forward” button representation 204 typically commands the computer to return to a web page that is above the current web page on a stack of URLs that have been visited during the current session. The “Stop” button representation 206 typically commands the computer 110 to stop loading the current web page. The “Refresh” button representation 208 commands the computer 110 to send a request to the web server 140 (FIG. 1) for the current web page, thus “refreshing” the current web page with any updates that have occurred since the web page was received. The “Home” button representation 210 commands the computer 110 to send a request for the web page that the user has specified as his or her “homepage”. One skilled in the art will also recognize the “Address” field representation 212. The “Address” field representation 212 is typically where the user can enter a URL and press the enter button to retrieve the web page associated with that URL. Of course, the present disclosure is not limited to being implemented through a browser, as would be understood by those skilled in the art of the present disclosure.

The issue tracking system opening screen representation 200 in one embodiment, among others, could include a “Home” link representation 214, an “Admin” link representation 216, a “Search” link representation 218, a “View Topics” link representation 220, and an “About iTracker” link representation 222. One skilled in the art should recognize that the issue tracking system could also include a welcome message representation 224. The “Home” link representation 214 would typically include a hyperlink back to the welcome page. From the opening screen representation 200, the “Home” link representation will typically reload the opening screen.

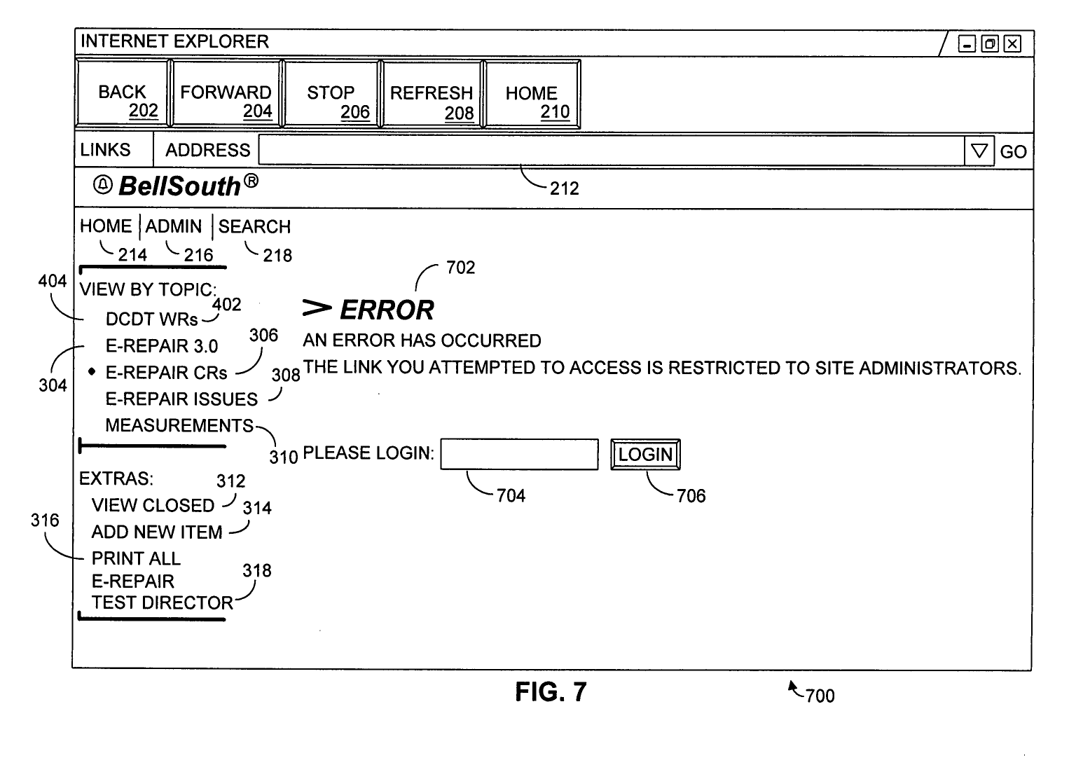

The “Admin” link representation 216 typically includes a hyperlink to an administration page. From the administration page an administrator would be allowed to sign in, and change various aspects of the issue tracking system. Some of these aspects are those to which normal users would not have access, such as adding a topic (also referred to herein as a project), editing an issue, deleting an issue or topic, or closing an issue. This section of the issue tracking system will be discussed in more detail with reference to FIGS. 7, 8, and 16-19.

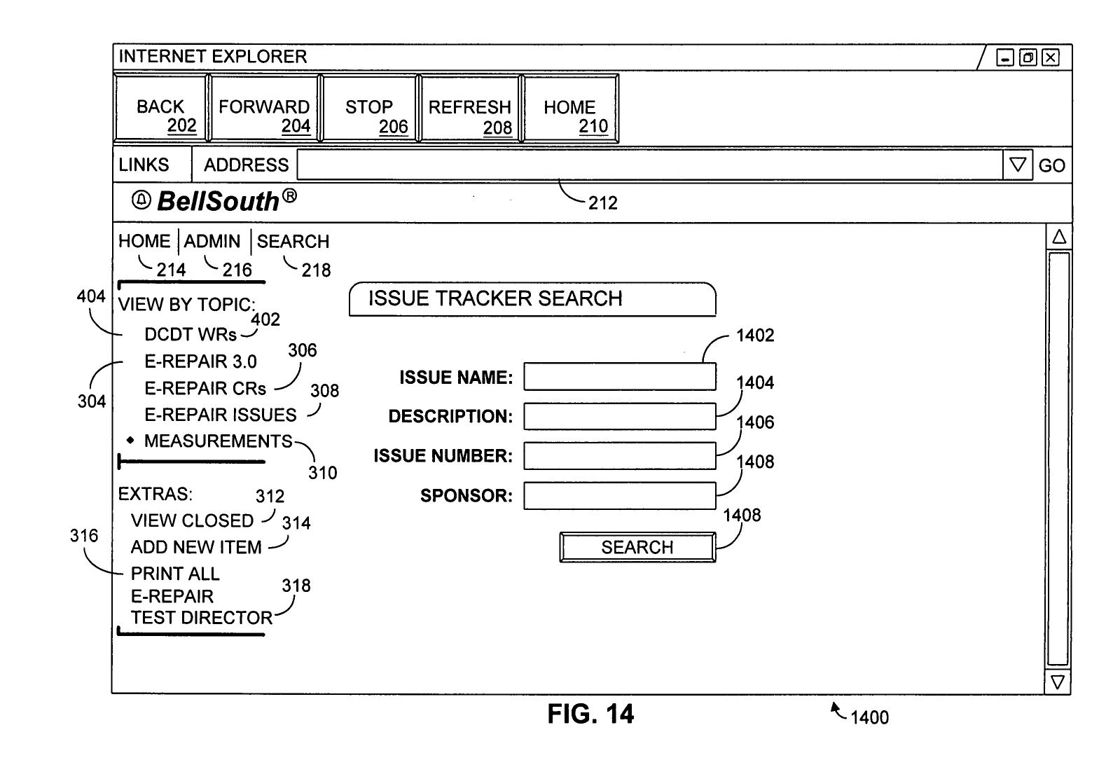

The “Search” link representation 218 typically includes a hyperlink to a search page, which is described in more detail with respect to FIG. 14. The search page allows the user to search for a particular topic, issue or item contained within the database 170 (FIG. 1).

The “View Topics” link representation 220 typically includes a hyperlink to a page which allows the user to view all of the topics for which the issue tracking system is keeping track. The topics are typically added to the issue tracking system by an administrator.

The “About iTracker” button representation 222 typically includes a hyperlink to a page which gives a short description of the issue tracking system. The description can include, among others, a short summary of the features and objects of the system, the creator's name, and/or an administrator's name.

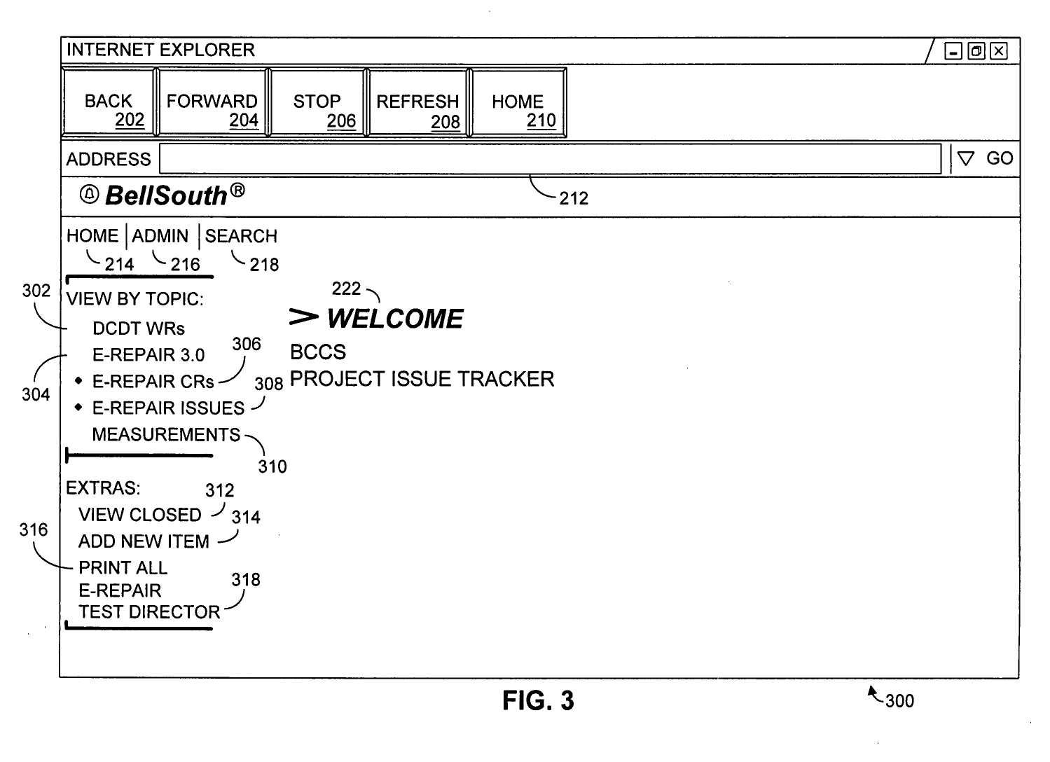

Referring now to FIG. 3, shown is a sample screen shot illustrating topics that are available to the user. A user would typically arrive at this page after selecting the “View Topics” button representation 220 from the screen shot shown in FIG. 2. Upon determining that the user has selected the “View Topics” button representation 220 of FIG. 2, the computer 110 (FIG. 1) would send a request including the URL associated with the “View Topics” button representation 220 to the web server 140 (FIG. 1). The web server would then retrieve the correct file from the database 170 (FIG. 1), and send an html file to the requesting computer 110 (FIG. 1).

The available topics screen representation 300 typically can include some of the same content as the welcome screen representation 200. In particular the button representations 202, 204, 206, 208, 210 and the address field representation 212 remain part of the browser representation throughout. The “Home,” “Admin,” and “Search” button representations 212, 214, 216, respectively, are included in one embodiment, among others, to help the user navigate the site more efficiently. The welcome message representation 222 can also remain since the user has not selected any content to view at this point.

The content shown in FIG. 3, includes a listing of topics. The listing of topics in this embodiment, among others, includes a “DCDT WRs” link representation 302, an “E-Repair 3.0” link representation 304, an “E-Repair CRs” link representation 306, an “E-Repair Issues” link representation 308, and a “Measurements” link representation 310.

The “DCDT WRs” link representation 302 typically includes a link to Data Communication and Delivery Team (DCDT) work request page. This page would typically include a list of a number of issues related to DCDT work requests. These work requests would typically be input by a person responsible for the issue. This person in one embodiment, among others, would typically be referred to as the sponsor.

The “E-Repair 3.0” link representation 304 typically includes a link to an E-Repair page. E-Repair is one example of an acceptable maintenance and repair interface that is web-based and designed to process trouble reports from customers and open a work force administration (WFA) trouble ticket. WFA is a software applications available from Telcordia Technologies, Inc. of Piscataway, N.J. The E-repair page would typically include a list of issues related to the E-Repair 3.0 group.

The “E-Repair CRs” link representation 306 typically includes a link to an E-Repair change request page. This page would typically include a list of issues related to E-Repair customer requests.

The “E-Repair Issues” link representation 308 typically includes a link to an E-Repair issues page. The E-Repair issues page typically includes a list of issues related to outstanding E-Repair issues which are related to an internal E-Repair group, as opposed to the change requests which come from both external requests and internal testing to request product enhancements.

The available topics screen representation 300 also typically includes a list of extra categories that are selectable by the user. In one embodiment, among others, these categories include: a “View Closed” link representation 312; an “Add New Item” link representation 314; a “Print All” link representation 316; and an “E-Repair Test Director” link representation 318.

The “View Closed” link representation 312 typically includes a link to a closed items page. The closed items page typically contains a list of those items or issues which have been resolved. In one embodiment, among others, of the present disclosure, an administrator closes an item to keep users from prematurely closing an item before there has been a real resolution.

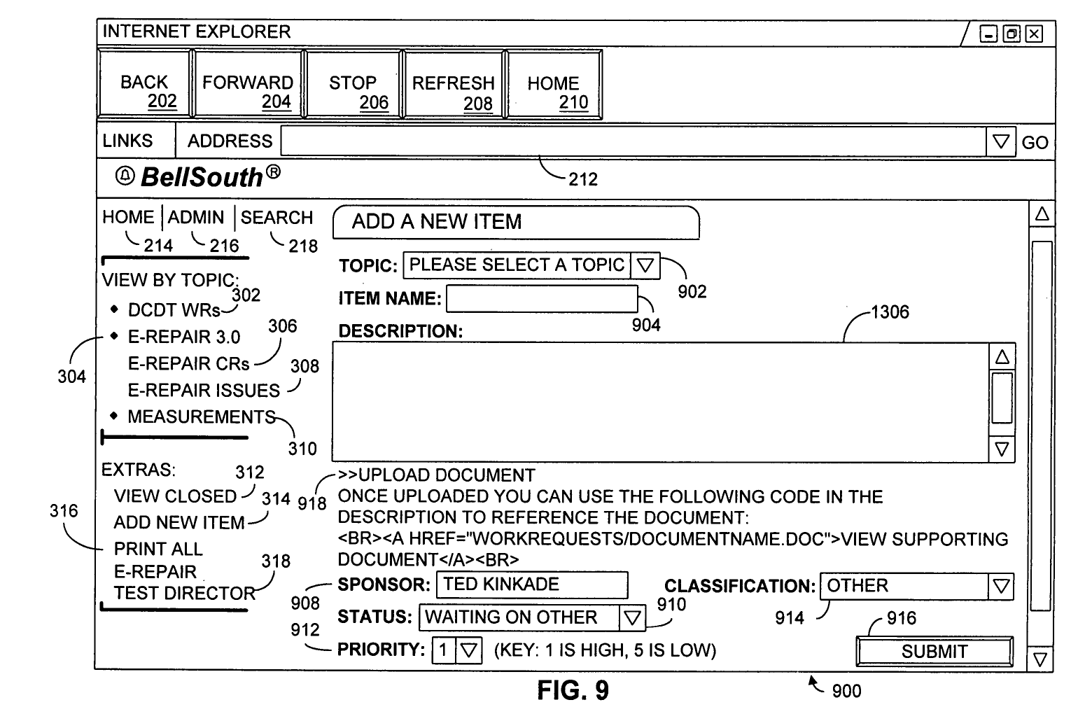

The “Add New Item” link representation 314 typically includes a link to an add new item page. The add new item page allows the user to add a new item to the database via an item table. The new item can be, among others, a problem ticket, an action item, a project completion milestone, etc. The add new item page will be discussed further with respect to FIG. 9.

The “Print All” link representation 316 includes a link to a command that sends a request to the computer to print all of the open issues associated with each of the projects listed. Typically a manager would use this function to retrieve the open items to take to, for example, a weekly meeting. Each of the open items could be reviewed to update the manager on the status of the item, and whether or not the item has been resolved or determine reasons that a resolution has not been made.

The “E-Repair Test Director” link representation 318 includes a link to a file repository page where files can be uploaded to the central database 170 (FIG. 1) by “E-Repair” group members. These files can be rather large, and as such, inefficient for a user to transfer the information contained within the file to the issue tracking system format. For example, spreadsheets and databases can include thousands of entries which a user might previously be required to enter manually. Requiring a user to enter each of these entries manually can be costly. Moreover, these files are also typically in a particular format that would be inefficient for users of the files to transfer to another format. For example, an existing database or spreadsheet may contain only a portion of the information for which the issue tracking system prompts the user. Thus, a user may have previously been required to gather further information about each of the issues included in the existing database or spreadsheet. Such a process is similarly time consuming and costly. Thus, the files are uploaded to the central database 170 without changing the format.

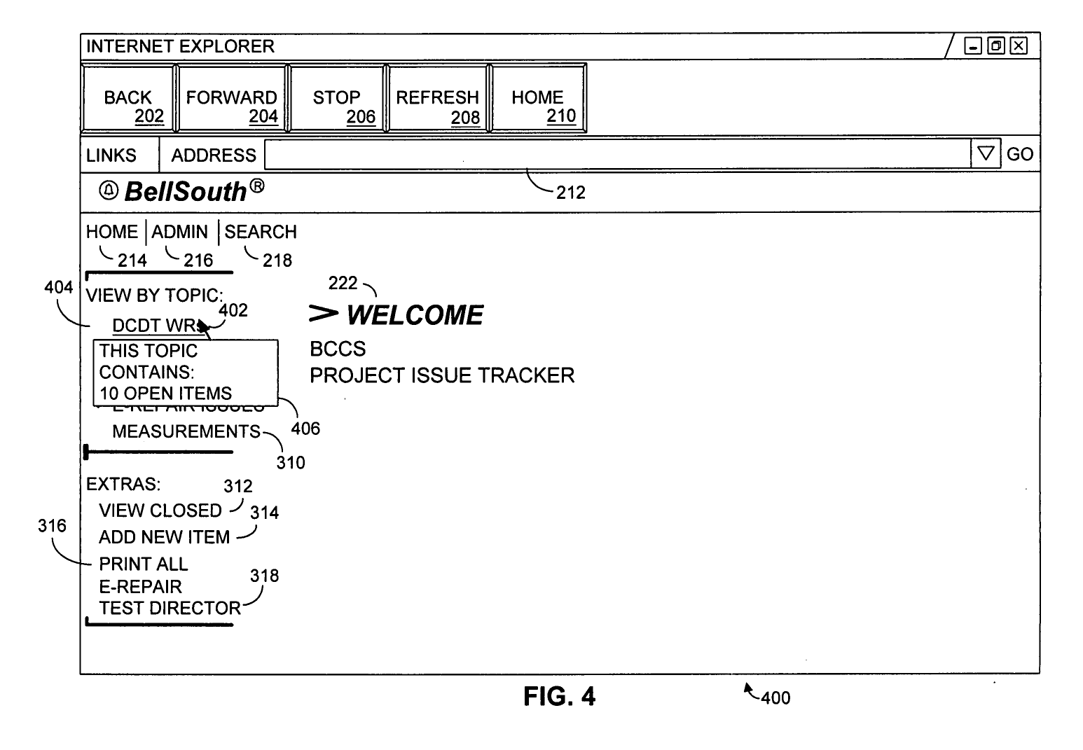

Referring now to FIG. 4, shown is a sample screen shot 400 of the available topics screen representation of FIG. 3 that includes a mouse over feature included to let the user know how many open items remain in a particular topic. In particular, the “DCDT WRs” link representation 302 (FIG. 3) becomes an underlined link representation 402 when a mouse pointer representation 404 is moved over the link representation 302 of FIG. 3. Moreover, an information pane 406 appears under the mouse pointer representation 404 when the mouse pointer representation 404 is moved over a link representation 302 (FIG. 3). One skilled in the art should recognize that the information pane 406, with information about a link representation 304 . . . 318 (FIG. 3), could appear when the mouse pointer representation 404 is moved over any of the link representations 304 . . . 318 of FIG. 3.

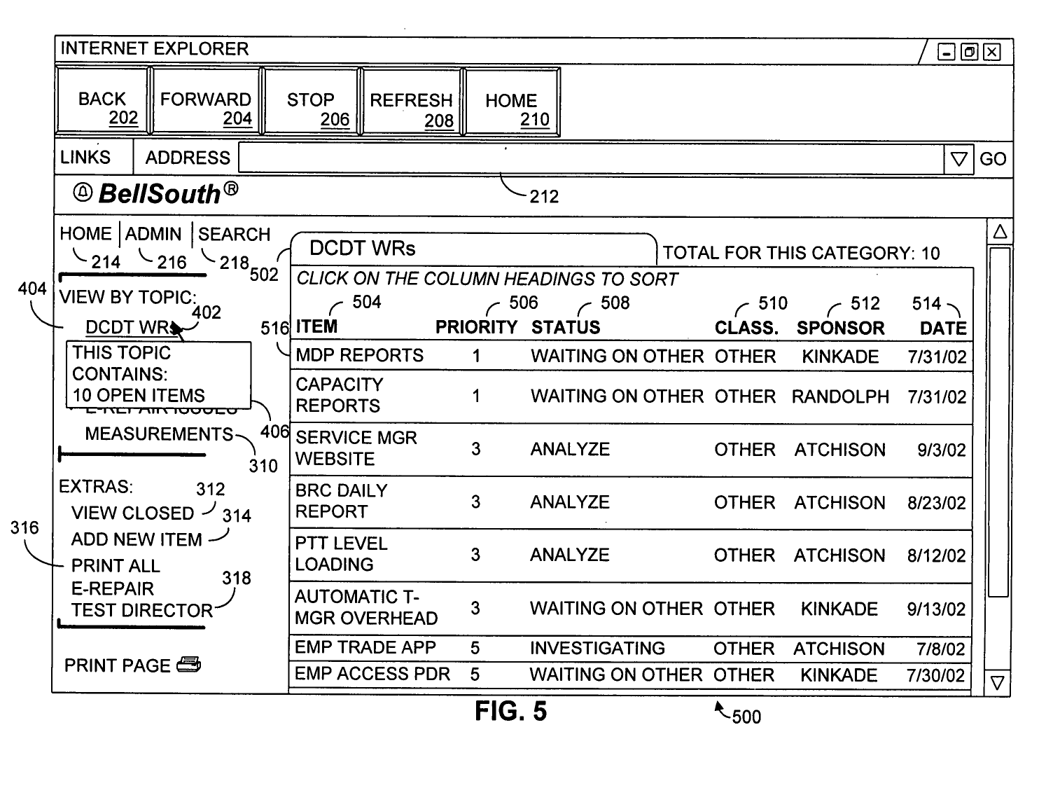

Referring now to FIG. 5, shown is a sample screen shot of an embodiment, among others, of the DCDT work request page representation 500 linked by link representation 302 (FIG. 3). The DCDT work request page representation 500 typically includes, among others, a DCDT items list representation 502. The items list representation 502 can typically include a number of rows. Each row can typically be broken down into several columns 504 . . . 514. In the present embodiment, among many others, the columns are entitled “Item,” “Priority,” “Status,” “Class,” “Sponsor,” and “Date.” Moreover, in this embodiment, among others, the rows can be sorted according to the column headers by clicking a column header link representation 504-514. By selecting the “Items” column header representation 504, the rows can be sorted by an issue number associated with the item. One skilled in the art should recognize that there are myriad ways to sort the columns for user comprehension, and that each of these is intended to be included within the scope of the present disclosure.

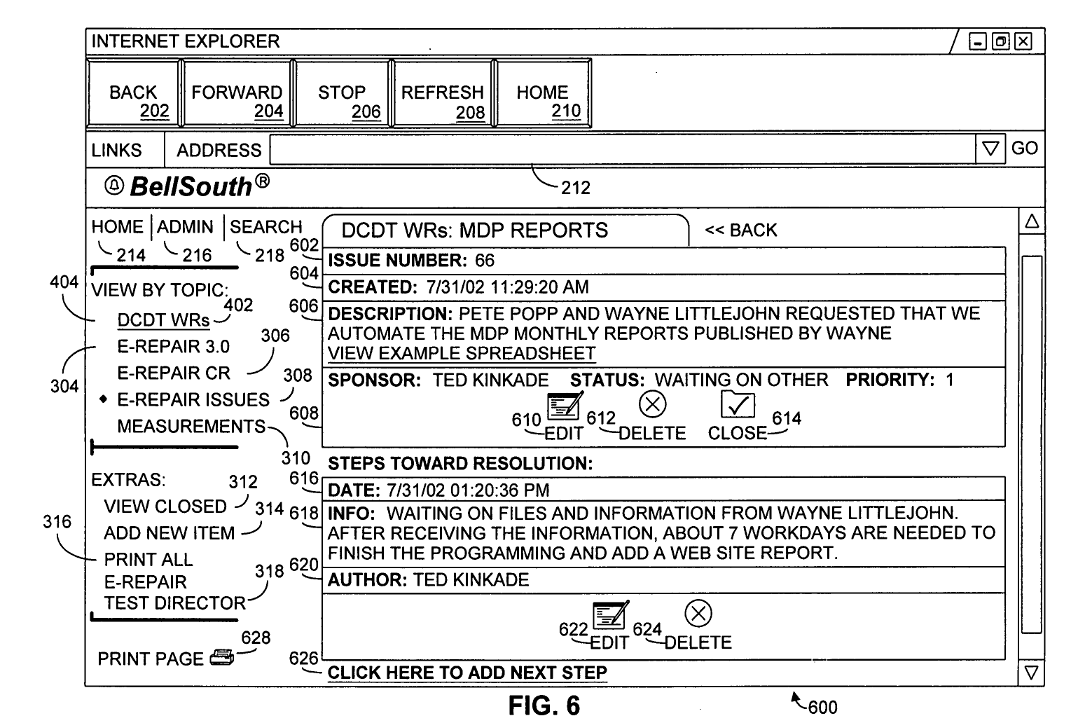

Furthermore, each row can be made selectable such that a user can use the mouse pointer representation 402 to select an item, such as the “MDP Reports” item row representation 516. Upon selecting the “MDP Reports” item row representation 516, the user's computer 110 will retrieve the web page associated with the item entitled “MDP Reports,” which is discussed further with respect to FIG. 6. One skilled in the art should recognize that each of the other rows (not labeled) can be selectable in this manner as well.

Referring now to FIG. 6, shown is a sample screen shot of an MDP Reports page representation 600. This web page representation 600 typically can include, among others, an issue number field representation 602, a date created representation 604, a description representation 606, and a sponsor, status and priority representation 608. The issue number is typically a unique number assigned to each item added to the system in the order in which the items were added. The date created representation would include a timestamp associated with the date and time the item was created and added to the database 170 (FIG. 1). The description representation can typically be a brief description of the item or issue, and can further hyperlink to any supporting documents or include attachments similarly to electronic-mail. Attachments can be uploaded using Visual Basis (VB) script, as one example, among others. Visual Basic is available from Microsoft Corp. of Redmond, Wash. The sponsor status and priority representation includes the sponsor of the issue (e.g. the user who created the item or issue), a status for the issue which typically represents the next step that needs to be taken, and a priority for the issue which typically indicates the severity of the issue or the importance that the issue be resolved quickly. One skilled in the art should recognize that many other categories could be included to describe pieces of each issue, and it is intended that these such issues are within the scope of the present disclosure.

The sponsor, status and priority representation 608 can include both an “Edit” icon representation 610, a “Delete” icon representation 612, and a “Close” icon representation 614. The “Edit” icon representation 610 would typically allow a user to edit the description, sponsor, status and priority of an item. The “Delete” icon representation 612 would typically allow a user to delete the current item from the database 170 (FIG. 1). The “Close” icon representation 614 would typically allow a user to close the current item. In one embodiment, among others, these functions could be limited to administrators. In the case where these functions were limited to administrators, the icons would include a link to a page requiring a user to be logged in as an administrator. If the user was not logged in as an administrator, the web server 140 (FIG. 1) would send an error page to the computer 110. The error page will be discussed in more detail with reference to FIG. 7.

The “MDP Reports” page representation 600 can also include a number of steps toward resolution. Each such step toward resolution can include, among others: a date representation 616, which typically includes the date upon which the step was added or taken; an information representation 618, which typically includes information about the step taken; an author representation 620, which typically includes the name of the user who added the step, or the name of the person who performed the step; an “Edit” icon representation 622, which could allow the user to edit the step; and, a “Delete” icon representation 624, which could allow the user to delete the step. One skilled in the art should recognize that the edit and delete functions could be limited to administrators in order to reduce mistakes and/or subversion of the issue tracking system.

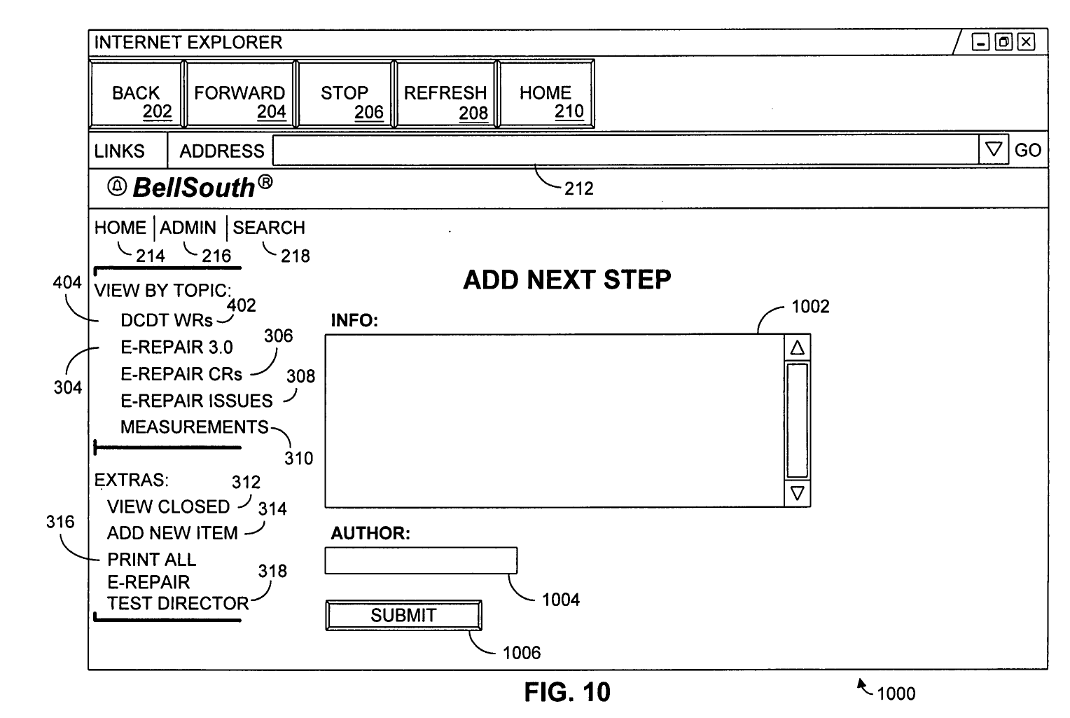

Typically, if the user wishes to add a new step toward resolution, an “Add Next Step” link representation could be provided. The “Add Next Step” link representation typically could include a link to an “Add Next Step” page which would allow the user to add a new step toward resolution. The “Add Next Step” page will be discussed in further detail with respect to FIG. 10. Moreover, if the user wishes to print the issue and the steps taken towards resolution, he or she could select a “Print Page” icon representation 628.

Referring now to FIG. 7, shown is a sample screen shot of an “Error” page representation 700 which would be sent to the user if he or she attempted to use a restricted page and was not logged in as an administrator. The “Error” page representation 700 can typically include, among others: an error message representation 702, stating that the user has attempted to access a page restricted to administrators; a login field representation 704, allowing an administrator to type in his or her password; and, a login button representation 706, allowing the user to submit the password typed into the login field representation to the web server 140 (FIG. 1). If the password is correct, the web server 140 (FIG. 1) can allow the user to access those portions of the issue tracking system that may be reserved for administrators. One skilled in the art should recognize that this password mechanism could also be tied into a larger username and password database such that the database 170 would not be required to remember an administrator's password. Moreover, each user in the password database could be given a specified level of access based upon a profile associated with the username and password.

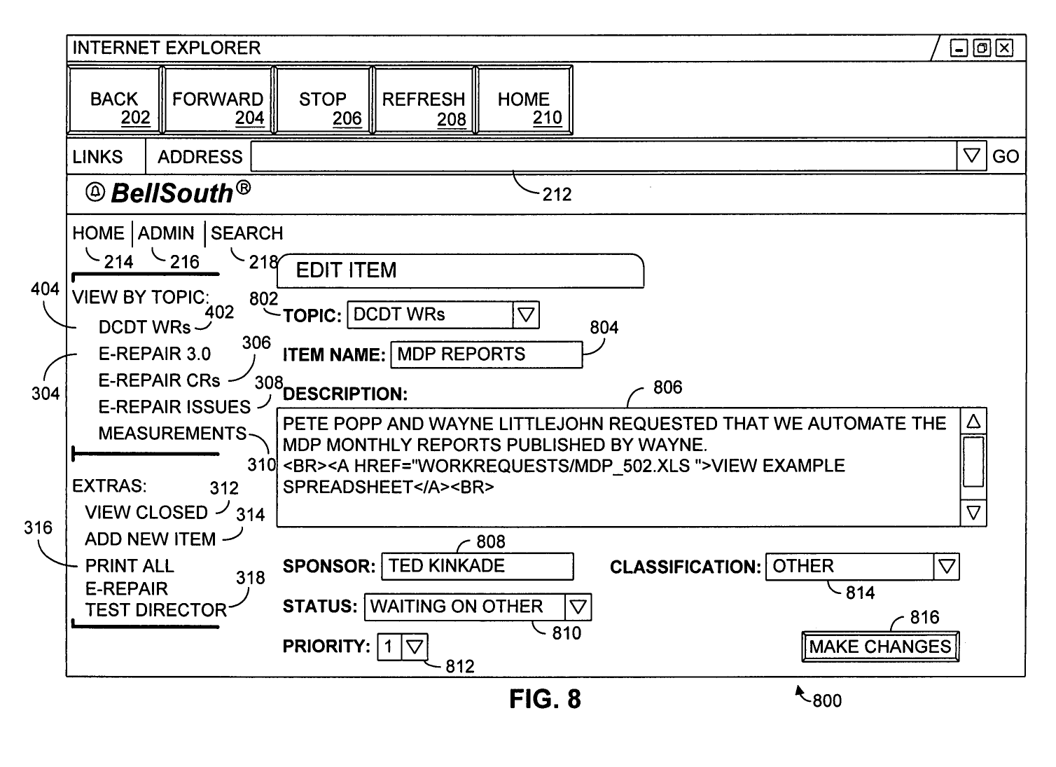

Referring now to FIG. 8, shown is a sample screen shot of an “Edit Item” page representation 800 available for administrators in one embodiment, among others, of the present disclosure. The “Edit Item” page representation 800 can typically include, among others: a “Topic” pull-down menu representation 802; an “Item Name” field representation 804; a “Description” field representation 806; a “Sponsor” field representation 808; a “Status” pull-down menu representation 810; a “Priority” pull-down menu representation 812; a “Classification” pull-down menu representation 814; and, a “Make Changes” button representation 816.

The “Topic” pull-down menu representation 802 could typically allow the user to change the topic or project under which the item is listed. In the embodiment shown, among others, the “Topic” pull-down menu representation 802 could include, among others: “DCDT WRs”; “E-Repair 3.0”; “E-Repair CRs”; “E-Repair Issues”; and “Measurements”. Each of these topics were available on the “View Topics” page representation 300 of FIG. 3, and are included in the database 170. As is known in the art, a pull-down menu representation 802, allows a user to use a mouse pointer representation to select the menu, and scroll through a number of options. Furthermore, the pull-down menu representation would typically default to the current assignment of the item or issue.

The “Item Name” field representation 804 is typically pre-populated with the name of the item selected to edit. The field representation 804 would allow the user to rename the item or issue previously selected. Similarly, the “Description” field representation 806 is typically pre-populated with the description of the item or issue. The user is thus able to edit the description to correct errors and/or omissions. The “Sponsor” field representation 808 is typically pre-populated with the name of the person previously sponsoring the issue. A user could change the sponsor from this page.

The “Status” pull-down menu representation 810 typically includes a plurality of status identifiers that can be used with regard to the item. Shown is the status identifier that previously described the item which the user chose to edit. In this instance, the status is identified as “Waiting on Other.” This status identifier is typically used when the user is waiting on another person to take a step before the item or issue can be advanced. In one embodiment, among others, the status identifiers can include: Analyze, Completed, Current Release, Data Re-Run Required, Future Release 1, Future Release 2, Investigating, Requires Further Definition, Unknown, Waiting on Other, and Pending Verification. These status identifiers are hard-coded into the system, thus, one skilled in the art should recognize that the administrator can change these identifiers according to the types of items of which the users of the system would like to keep track. However, in the present embodiment, among others, the identifiers are fairly self explanatory. “Analyze” typically represents that a group member is looking into the issue. “Completed” typically represents that the issue has been completed. “Current Release” typically represents that a change or fix is in a current release of a product. “Data Re-run Required” typically indicates that a problem has necessitated a data re-run. “Future Release 1” and “Future Release 2” typically indicate that a change has been planned for a future release. “Investigating” is similar to analyze and typically indicates which group is looking into an issue or change. “Requires Further Definition” typically indicates that an issue has not been sufficiently identified so that an investigator can correct the issue. “Unknown” typically indicates that the status is unknown. “Waiting on Other” typically indicates that another person or group is making a change prior to the investigator being able to solve the current issue. “Pending Verification” typically indicates that a change has been made and is awaiting verification that the change resolves the issue. One skilled in the art should recognize that these status identifiers are merely exemplary, and that a plethora of other identifiers could be used, and are intended to be included within the scope of the present disclosure.

Similarly to the “Status” pull down menu representation 810, the “Priority” pull-down menu representation 812 typically includes a plurality of pre-defined priority identifiers. In an embodiment, among others, of the present disclosure, the priority identifiers are numbered 1 to 5, with 1 being the highest priority and 5 being the lowest priority. Likewise, the “Classification” pull-down menu representation 814 typically includes a plurality of pre-defined classifications. These pre-defined classifications can include, among others: revenue growth, revenue retention, revenue supporting, cost avoidance, and cost savings. These classification identifiers can be used by management to determine the costs of a specific issue, what is spent on certain kinds of issues, etc. One skilled in the art should recognize that there exist myriad status, priority, and classification identifications descriptors, and that each of these descriptors is intended to be included within the scope of the present disclosure. Once the user has made all the changes that he or she wishes to make to the item or issue, he or she can use the mouse pointer representation to select the “Make Changes” button representation 816. The “Make Changes” button representation submits the new item to overwrite the older item. In some embodiments, among others, of the present disclosure, a confirmation is included assure that a change is not made inadvertently. As one skilled in the art should recognize, the confirmation could take the form of a “pop-up” confirmation which requires that the user select a “yes” representation to continue with the change. Alternatively, the confirmation could be a “confirmation” page representation requiring that the user click a confirmation button representation to continue with the change.

Referring now to FIG. 9, shown is a sample screen shot of an embodiment, among others, of an “Add New Item” page representation 900. The “Add New Item” page representation is typically received after selecting the “Add New Item” link representation 314 (FIGS. 3-10, 12-14). The “Add New Item” page representation 900 typically can include, among others: a “Topic” pull-down menu representation 902; an “Item Name” field representation 904; a “Description” field representation 906; a “Sponsor” field representation 908; a “Status” pull-down menu representation 910; a “Priority” pull-down menu representation 912; a “Classification” pull-down menu representation 914; and, a “Submit” button representation 916.

The “Topic” pull-down menu representation 902 allows the user to select a topic from any of the topics that are present in the database 170 (FIG. 1). The user would then enter an item name into the “Item Name” field representation 904, and enter a description of the item into the “Description” field representation 906. The user typically could add his or her name into the system through the “Sponsor” field representation 908, choose the status, priority and classification of the item using the “Status” pull-down menu representation 910, the “Priority” pull-down menu representation 912, and the “Classification” pull-down menu representation 914, respectively. Once all fields have been selected, the user could typically use the mouse pointer to select the “Submit” button representation 916.

Referring now to FIG. 10, shown is a sample screen shot of an “Add Next Step” page representation 1000. The “Add Next Step” page representation 1000 can typically include, among others, an “Information” representation 1002, an “Author” field representation 1004, and a “Submit” button representation 1006. The “Information” representation 1002 could be used by the user to enter information about the step taken and any information about the next step or new status of the item or issue. The “Author” field representation 1004 is typically where the user entering the step would enter his or her name to identify the person responsible for the step if an problem later arises. The “Submit” button representation 1006 is used to actually submit the step to the web server 140 (FIG. 1).

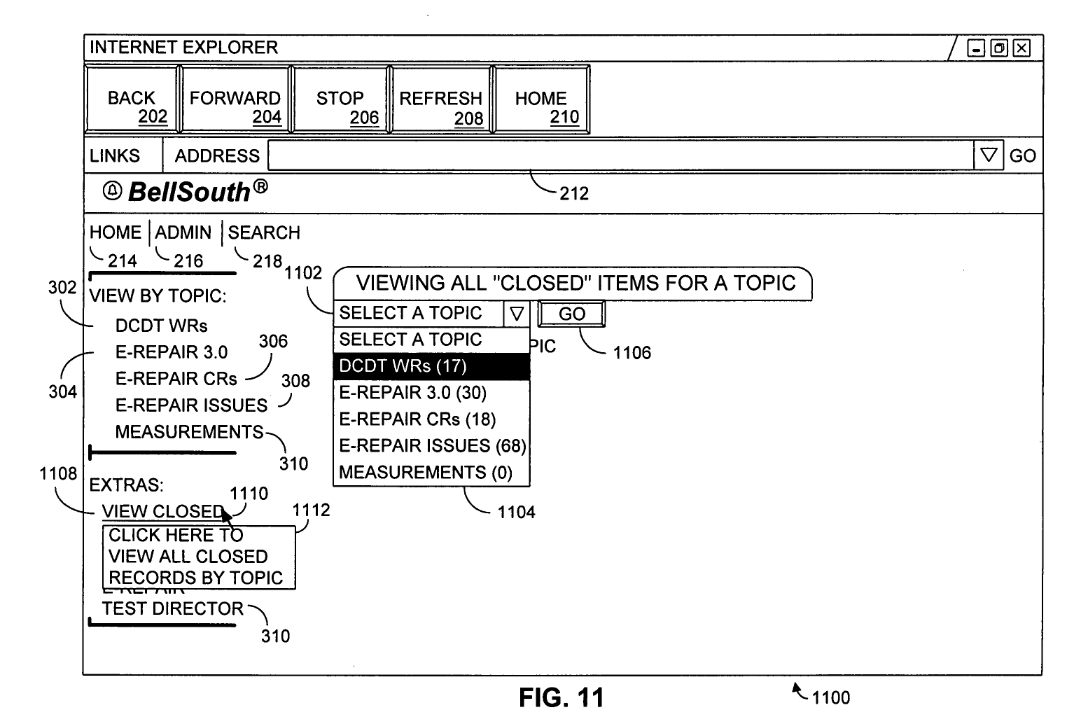

Referring now to FIG. 11, shown is a sample screen shot illustrating a “View Closed” page representation 1100. The “View Closed” page representation 1100 typically would be sent to the computer 110 (FIG. 1) upon the user selecting the “View Closed” link representation 312 of FIG. 3. Typically, the “View Closed” page representation could include a “Select A Topic” pull-down menu representation 1102. The user can typically either tab to the pull-down menu 1102, or use the mouse pointer representation to select the pull-down menu representation 1102. The “Select A Topic” pull-down menu representation 1102 will typically include a topic list representation 1104 which displays the topics available for selection. Upon selecting a topic, the list representation 1104 would typically collapse, and display the selected topic. The user could then use the “Go” button representation 1106 to request the selected topic from the web server 140 (FIG. 1). The “Go” button representation 1106 can typically be selected using the mouse pointer or by pressing the tab key on a keyboard until the button is highlighted, and then pressing the enter key.

One skilled in the art might also notice that the “View Closed” link representation 1108 has been “moused-over” by the user. Similarly to the “mouse-over” shown with respect to FIG. 4, when a user moves the mouse pointer representation 1110 over the “View Closed” link of FIG. 3, an information pane 1112 can appear to give the user information about the page that is linked to the link representation 1108.

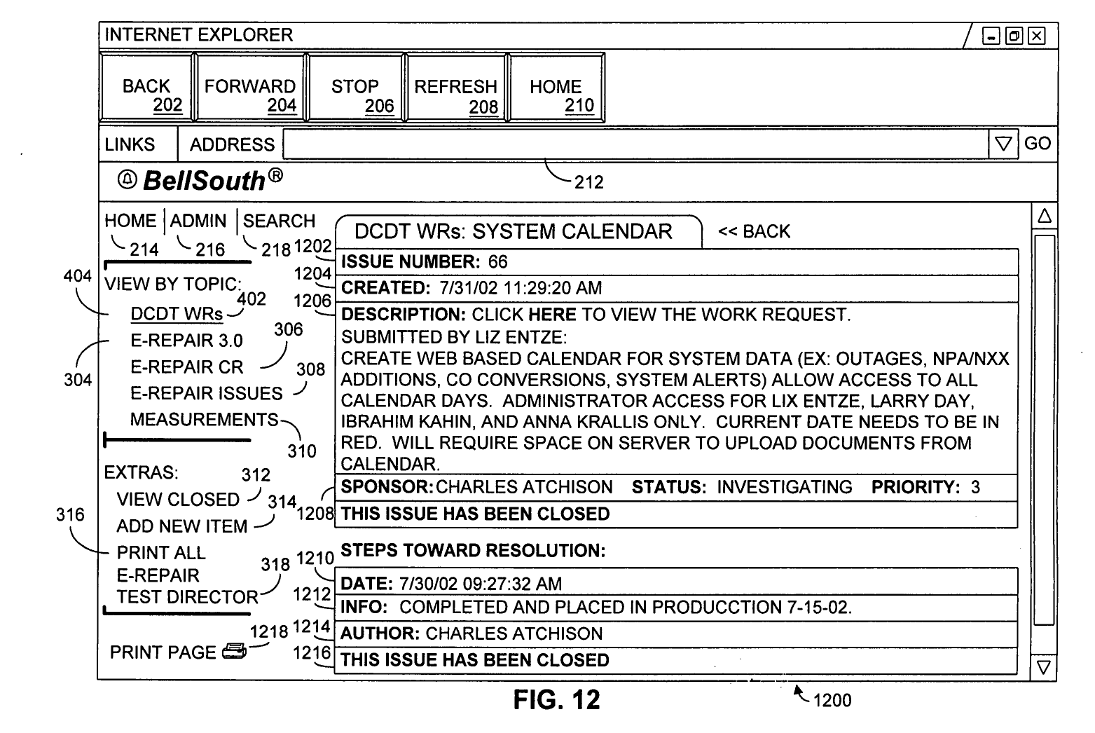

Referring now to FIG. 12, shown is a sample screen shot of an embodiment, among others of a “Closed Items” page representation 1200. A “Closed Items” page representation 1200 would typically resemble the “MDP Reports” page representation 600 shown with respect to FIG. 6. The “Closed Items” page representation 1200 typically includes an issue description including, among others: an “Issue Number” representation 1202; a “Creation Date” representation 1204; a “Description” representation 1206; a “Sponsor” representation 1208. Moreover, the “Closed Items” page representation 1200 typically includes any “Steps Toward Resolution”, including, among others: a “Date” representation 1210; an “Information” representation 1212; and, an “Author” representation 1214. Further, the “Closed Items” page representation will typically conclude with a message 1216 stating that the issue has been closed. One skilled in the art should recognize that managers may also wish to print this page, and in one embodiment, among others, a “Print Page” icon representation 1218 has been included to print the page corresponding to the closed items being viewed.

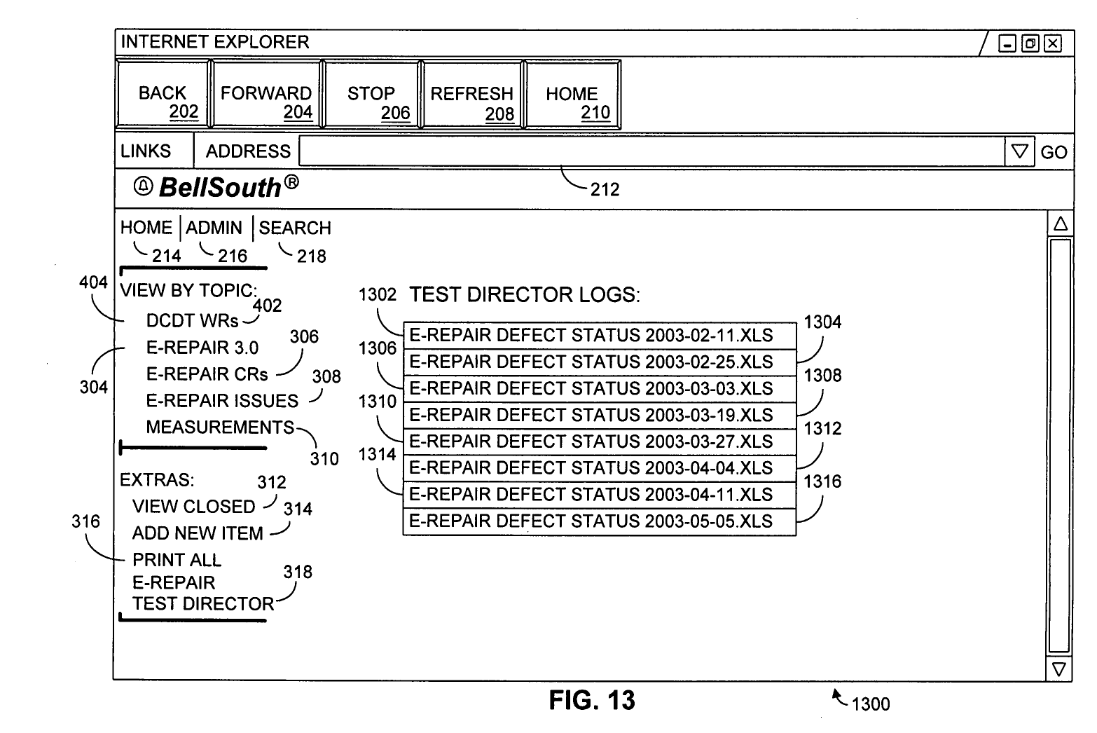

Referring now to FIG. 13, shown is a sample screen shot of an embodiment, among others, of an “E-Repair Test Director” page representation. Each of the rows 1302-1316 can typically include a filename representation. The filename representation in each row 1302-1316 can be programmed as links, such that the user could view a file by selecting one of the filenames. In one embodiment, among others, these files are Excel spreadsheet files. Excel is a spreadsheet program available from Microsoft, Corp. of Redmond, Wash.

Referring now to FIG. 14, shown is a sample screen shot of an embodiment, among others, of a “Search” page representation 1400. The “Search” page representation 1400 typically can include a number of fields upon which the user can search. Each of the fields searches a separate field of the issues database table. In one embodiment, among others, the fields can include: an “Issue Name” field representation 1402, a “Description” field representation 1404, an “Issue Number” field representation 1406, and a “Sponsor” field representation 1408. Any of the individual field representations can be utilized to obtain search results. Moreover, any combination of the field representation can be utilized to obtain search result. Furthermore, in one embodiment, among others, of the present disclosure the database 170 (FIG. 1) is an Access database, which allows users to use any of the shortcuts available in Access to search. One skilled in the art would recognize that Access is a database software program available from Microsoft, Corp. of Redmond, Wash., which allows users to create database structures. One skilled in the art should also recognize that there are other database programs that could be used in conjunction with other embodiments of the present disclosure.

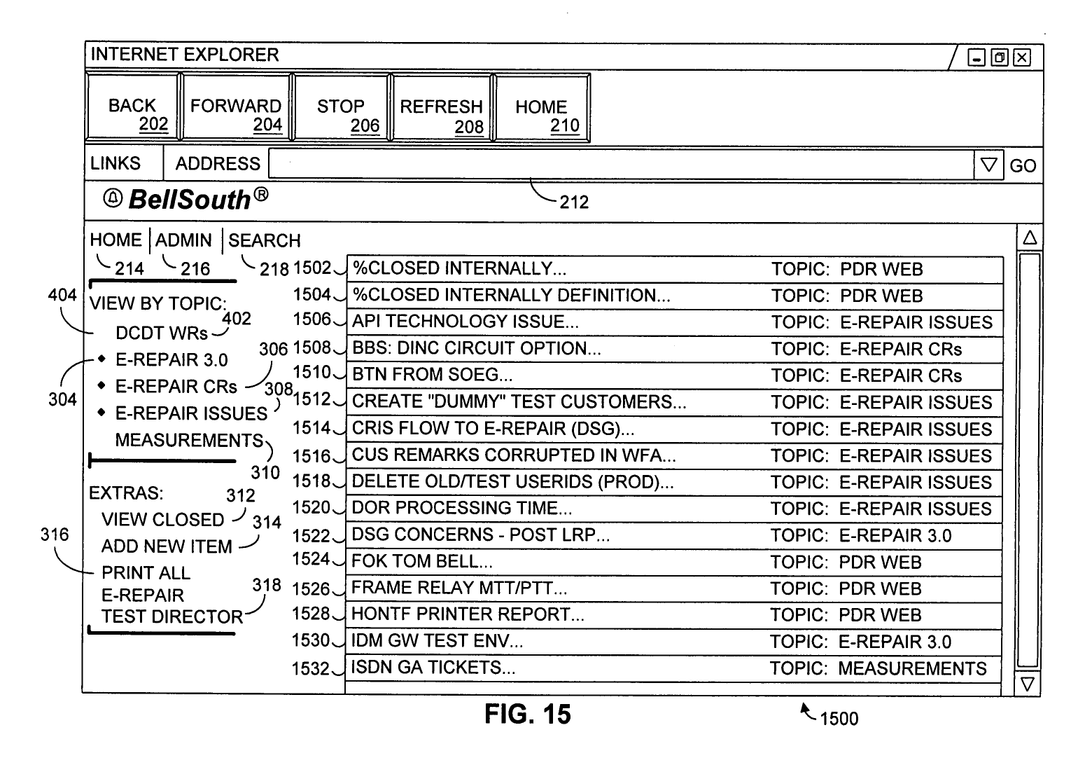

Referring now to FIG. 15, shown is a sample screen shot of an embodiment, among others, of a “Search Results” page representation 1500. The “Search Results” page representation 1500 can typically include a number of rows 1502-1532. Each of the rows 1502-1532 in one embodiment, among others, includes an issue name representation and a topic name representation for that issue. Moreover, each of the issue names include a link, such that a user can view the details of an issue by using the mouse pointer to select any of the issue names.

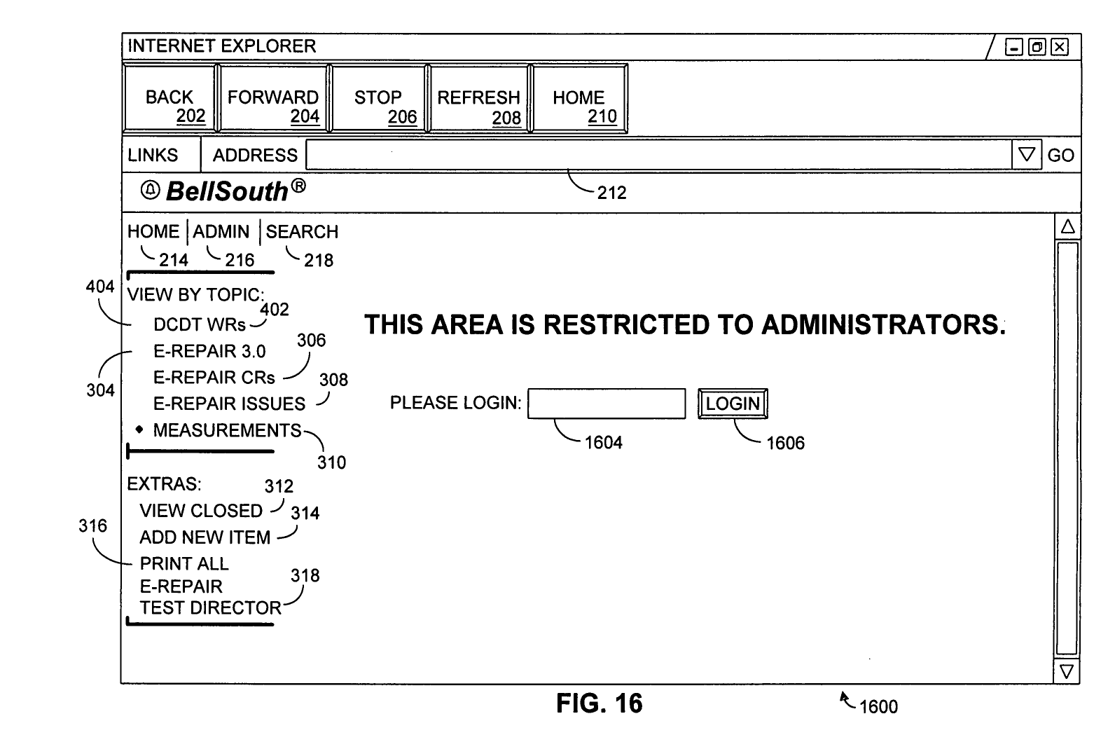

Referring now to FIG. 16, shown is a sample screen shot of an embodiment, among others, of a “Admin Login” page representation 1600. This screen can typically be accessed by selecting the “Admin” link representation 216. The “Admin Logic” page representation 1600 typically can include a “Login” field representation 1604 and a “Login” button representation 1606. To login, the user could typically enter his or her password into the “Login” field representation, and select the “Login” button representation using the mouse pointer. One skilled in the art should recognize that a username and password combination could be used here, and that the web server 140 (FIG. 1) could be connected to a centralized authentication database containing a plurality of usernames and passwords for a group of people.

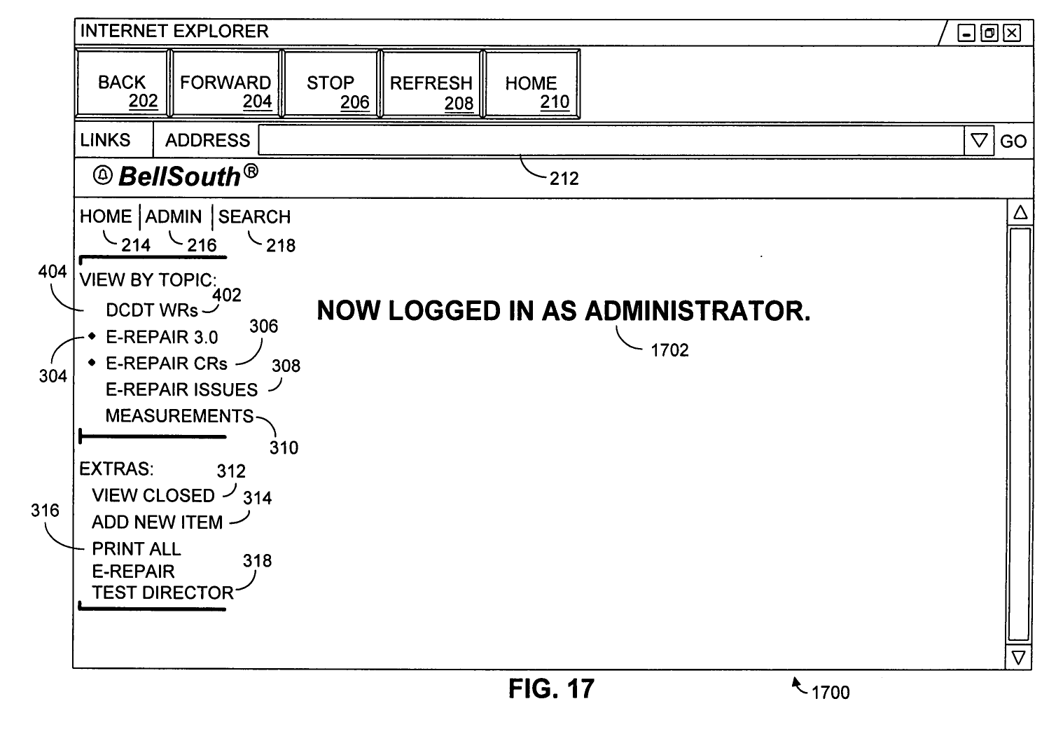

Referring now to FIG. 17, shown is a sample screen shot of an embodiment, among others, of a “Login confirmation” page representation 1700. The “Login confirmation” page representation 1700 can typically include a message representation 1702 confirming that the user is now logged in as an administrator.

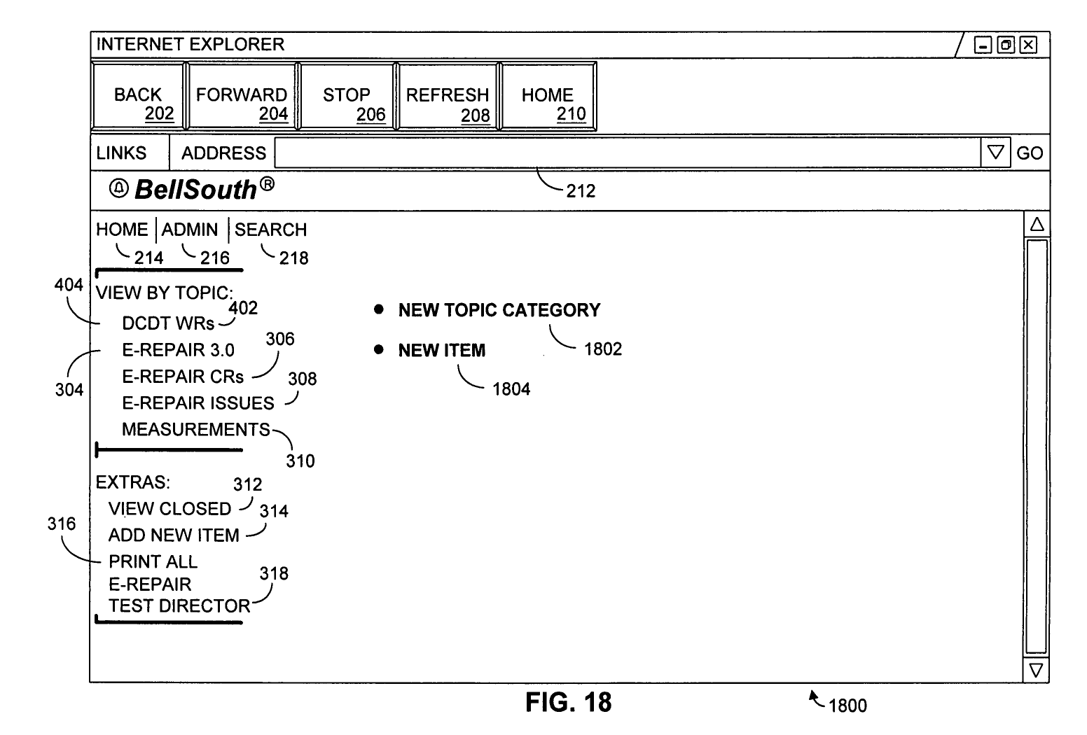

Referring now to FIG. 18, shown is a sample screen shot of an embodiment, among others, of an “Admin” page representation 1800. The “Admin” page representation can be accessed by selecting the “Admin” link representation 216 after logging in to the system. The administrator can typically choose either an “Add Topic Category” link representation 1802, or an “Add Item” link representation 1804. If the administrator chooses the “Add Item” link representation 1804, the web server 140 (FIG. 1) retrieves and sends the “Add Item” page representation of FIG. 9 to the admin computer 160 (FIG. 1). If the administrator chooses the “Add Topic Category” link representation 1802, the web server 140 (FIG. 1) retrieves an “Add New Topic” page representation 1900 and sends it to the admin computer 160 (FIG. 1).

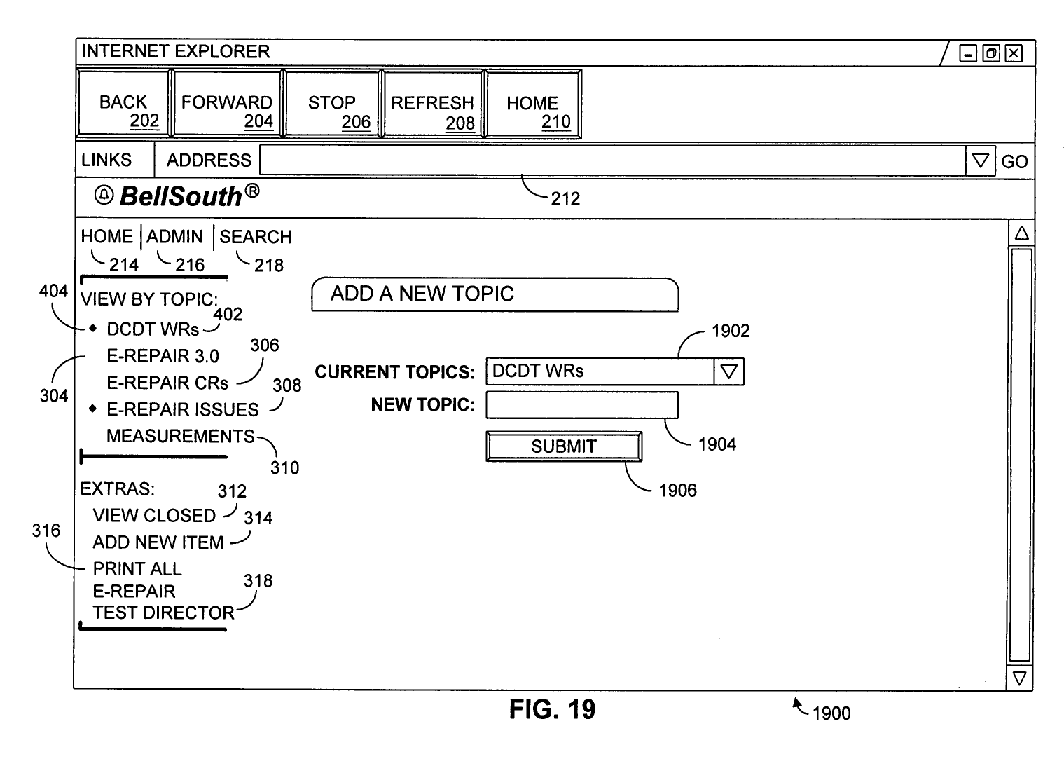

Referring now to FIG. 19, shown is a sample screen shot of an embodiment, among others, of an “Add New Topic” page representation 1900. The “Add New Topic” page representation 1900 typically allows the user to add a new topic to the database 170 (FIG. 1). The “Add New Topic” page representation 1900 is typically requested via the “Admin” page representation 1800. The “Add New Topic” page representation 1900 in one embodiment, among others, can include: a “Current Topics” pull-down menu representation 1902, a “New Topic” field representation 1904, and a “Submit” button representation 1906. The “Current Topics” pull-down menu representation 1902 can be used by the user to determine whether or not a topic already exists for his or her topic/project. The user can enter a new topic into the “New Topic” field representation 1904, and can send the new topic to the database 170 (FIG. 1) by selecting the “Submit” button representation 1906 using the mouse pointer.

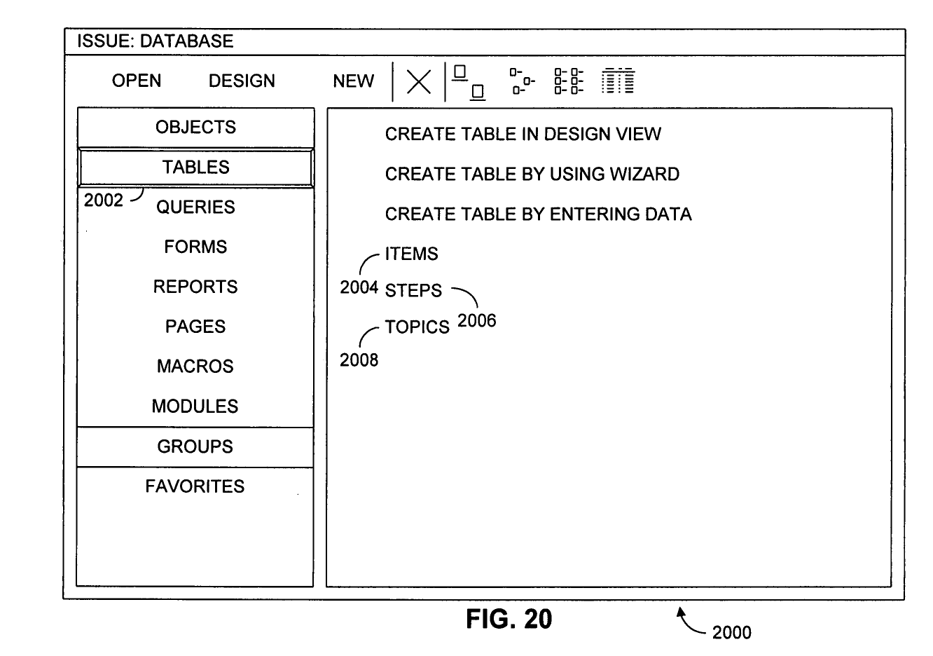

Referring now to FIG. 20, shown is a screen shot 2000 of an Access database programming interface showing a table structure for a database which stores information in an embodiment, among others, of the present disclosure. One skilled in the art should readily understand the database programming interface shown. The table button representation 2002 is highlighted in the screen shot 2000. The tables that have been created for the issue tracking system in one embodiment, among others, include an “Items” table representation 2004, a “Steps” table representation 2006, and a “Topics” table representation 2008. Each of these tables can be opened by double clicking on the particular table the user wishes to open, or by highlighting the table and using the mouse pointer to click the “Open” button representation.

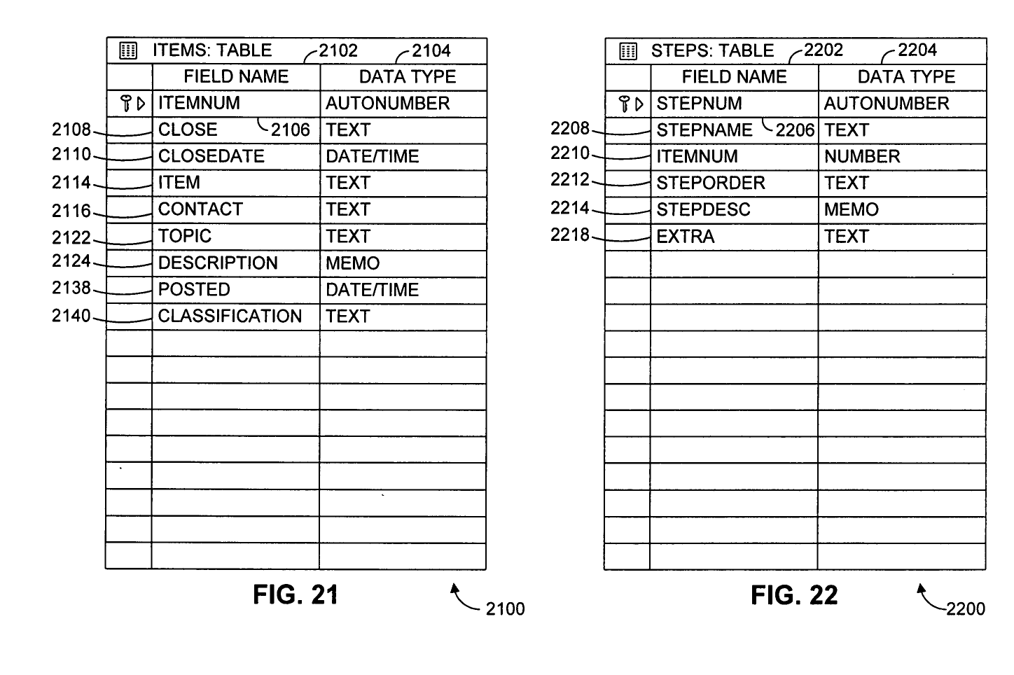

Referring now to FIG. 21, shown is an embodiment of the table structure representation 2100 of the “Items” table representation 2004 shown with respect to FIG. 20. In one embodiment, among others, the “Items” table representation includes a “Field Name” and a “Data Type” column representation 2102, 2104, respectively.

The “Field Name” column representation 2102 refers to the name given to each of the fields associated with the “Items” table. In one embodiment, among others, of the “Items” table, the “Field Name” entries can include: an “ItemNum” representation 2106, a “Close” representation 2108, a “CloseDate” representation 2110, a “IssueOrder” representation 2112, an “Item” representation 2114, a “Contact” representation 2116, a “Manufacturer” representation 2118, a “Category” representation 2120, a “Topic” representation 2122, a “Description” representation 2124, an “Image” representation 2126, a “B4Link” representation 2128, an “AftLink” representation 2130, a “Keywords” representation 2132, a “Blank” representation 2134, a “Password” representation 2136, a “Posted” representation 2138, and a “Classification” representation 2140.

Typically each of the field names attempt to refer to the field names shown discussed above. In particular, the “ItemNum” representation 2106 refers to the “Issue Number” field representation, and is an “AutoNumber” data type; the “Close” representation 2108 refers to whether or not the item has been closed, and is a “Text” data type; the “CloseDate” representation 2110 refers to the date that the item was closed (if closed), and is a “Date/Time” data type; the “Item” representation 2114 refers to the name assigned by the user to the item, and is a “Text” data type; the “Contact” representation 2116 refers to the person running the issue, and is a “Text” data type; the “Topic” representation 2122 refers to the topic to which the item belongs, and is a “Text” data type; the “Description” representation 2124 refers to the description of the item, and is a “memo” data type; the “Posted” representation 2138 refers to the time that the topic was posted, and is a “Date/Time” data type; the “Classification” representation 2140 refers to the classification field discussed above, and is a “Text” data type.

Referring now to FIG. 22, shown is an embodiment of the table structure representation 2200 of the “Steps” table representation 2006 shown with respect to FIG. 20. In one embodiment, among others, the “Steps” table representation includes a “Field Name” and a “Data Type” column representation 2202, 2204, respectively.

The “Field Name” column representation 2202 refers to the name given to each of the fields associated with the “Steps” table. In one embodiment, among others, of the “Steps” table, the “Field Name” entries can include: a “StepNum” representation 2206, a “StepName” representation 2208, a “ItemNum” representation 2210, a “StepOrder” representation 2212, a “StepDesc” representation 2212, a “StepImage” representation 2214, a “StepImage1” representation 2216, and an “Extra” representation 2218.

Typically each of the field names attempt to refer to the field names shown discussed above. In particular, the “StepNum” representation 2206 refers to a step number field associated with the step, and is an “AutoNumber” data type; the “StepName” representation 2208 refers to the date and time stamp for the issue step, and is a “Text” data type; the “ItemNum” representation 2210 refers to the issue number field, and is a “Number” data type; the “StepOrder” representation 2212 refers to the order that each of the steps takes, and is a “Text” data type; the “StepDesc” representation 2214 refers to the description entered about the step, and is a “Memo” data type; the “Extra” representation 2218 refers to the sponsor of the step, and is a “Text” data type.

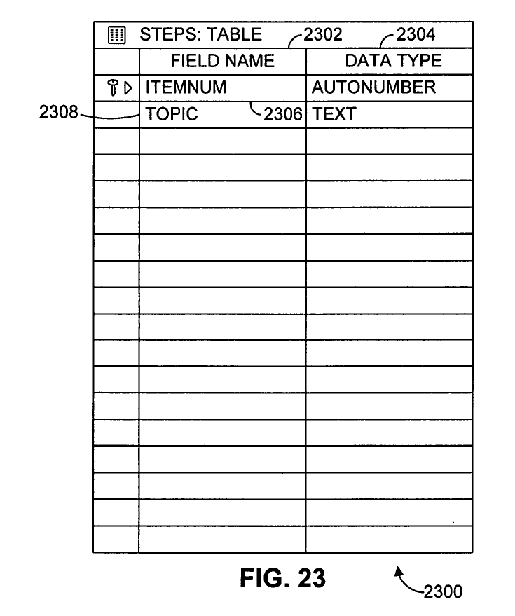

Referring now to FIG. 23, shown is an embodiment of the table structure representation 2300 of the “Topics” table representation 2008 shown with respect to FIG. 20. In one embodiment, among others, the “Topics” table representation includes a “Field Name” and a “Data Type” column representation 2302, 2304, respectively.

The “Field Name” column representation 2302 refers to the name given to each of the fields associated with the “Topics” table. In one embodiment, among others, of the “Topics” table, the “Field Name” entries can include: an “ItemNum” representation 2306, and a “Topic” representation 2308.

Typically each of the field names attempt to refer to the field names shown discussed above. In particular, the “ItemNum” representation 2306 refers to an issue number field associated with the issue, and is an “AutoNumber” data type; the “Topic” representation 2308 refers to the topic field, and is a “Text” data type.

Process and function descriptions and blocks in flow charts can be understood as representing, in some embodiments, modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure. In addition, such functional elements can be implemented as logic embodied in hardware, software, firmware, or a combination thereof, among others. In some embodiments involving software implementations, such software comprises an ordered listing of executable instructions for implementing logical functions and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a computer-readable medium can be any means that can contain, store, communicate, propagate, or transport the software for use by or in connection with the instruction execution system, apparatus, or device.

It should also be emphasized that the above-described embodiments of the present disclosure are merely possible examples of implementations set forth for a clear understanding of the principles of the disclosure. Many variations and modifications may be made to the above-described embodiment(s) of the disclosure without departing substantially from the principles of the disclosure. All such modifications and variations are intended to be included herein within the scope of this disclosure and the present disclosure and protected by the following claims.

1. An issue tracking system, comprising:
a centralized server operable to transmit a graphical user interface for tracking project issues over a network;
a database coupled to the centralized server operable to provide the graphical user interface to the centralized server, the database being further operable to track at least one issue related to a topic, to provide access through the centralized server to a plurality of users responsible for resolving said at least one issue, and to provide a storage option for a user to upload data formats which the user determines would be inefficient to manually enter using a format associated with the graphical user interface.

2. The system of claim 1, wherein the server is operable to communicate using a hypertext markup language.

3. The system of claim 1, wherein the centralized server is further operable to notify a responsible user when an issue is updated.

4. The system of claim 3, wherein the centralized server is operable to notify the responsible user via electronic mail when an issue is updated.

5. The system of claim 1, wherein the database has a table devoted to keeping track of at least one topic.

6. The system of claim 5, wherein the database has a table devoted to keeping track of at least one issue associated with said at least one topic.

7. The system of claim 6, wherein each of said at least one issue comprises a description of the issue, a status associated with said at least one issue, and a sponsor associated with said at least one issue.

8. The system of claim 7, wherein each of said at least one issue comprises a priority rating associated with said at least one issue.

9. The system of claim 6, wherein the database has a table devoted to keeping track of at least one step associated with said at least one issue.

10. The system of claim 9, wherein each of said at least one step associated with said at least one issue comprises a description of a step related to the resolution of said at least one issue.

11. The system of claim 5, wherein the database also maintains a list of persons responsible for a topic.

12. The system of claim 1, further comprising:
a network operable to transmit information stored in the database to a plurality of users.

13. The system of claim 12, further comprising:
a personal computer coupled to the network and having a browser operable to view the information received from the database via the network.

14. The system of claim 1, wherein the database is further operable to store issues that have been closed by a responsible user, and transmit information about the closed issue upon receiving a request for the information.

15. The system of claim 1, wherein the storage option is used for uploading a legacy spreadsheet file.

16. The system of claim 1, wherein the storage option is used for uploading a legacy database file.

17. A method of tracking project issues, comprising the steps of:
storing a project in a standardized format on a centralized database;
adding an issue associated with the project to the centralized database; and
enabling users to add at least one step taken to resolve the issue to the centralized database;
providing an option to a user to upload a data file which is in a data format which the user determines would be inefficient to convert to the standardized format.

18. The method of claim 17, further comprising the step of:
closing the issue upon resolution.

19. The method of claim 18, wherein the issue is closed after a responsible user sends a request to close the issue to a system administrator associated with the database.

20. The method of claim 17, further comprising:
adding an issue description to the centralized database.

21. The method of claim 20, wherein the issue description includes a status, a priority rating, and a sponsor.

22. The method of claim 17, further comprising:
adding a step description to the centralized database.

23. The method of claim 17, further comprising:
receiving a request from a user for the issue and said at least one step; and
providing the issue and said at least one step to a user.

24. The method of claim 23, wherein the issue and said at least one step are provided using hypertext transfer protocol via a network.

25. The method of claim 23, further comprising the steps of:
receiving a request from the user for all issues related to the project; and
providing all issues associated with the project.

26. The method of claim 25, further comprising the step of:
providing all issues associated with a project in a user sortable format based on an issue number associated with each issue, a status associated with each issue, a priority rating associated with each issue, a classification associated with each issue, and a sponsor associated with each issue.

27. The method of claim 17, further comprising the steps of:
receiving a request from a user to add a step to an issue;
adding the step to the centralized database; and
linking the step to the issue in the centralized database.

28. The method of claim 27, further comprising the step of:
storing a list comprising a plurality of responsible users for a project.

29. The method of claim 28, further comprising the step of:
notifying the plurality of responsible users when an issue has been updated or closed.

30. A computer readable medium having a program for tracking project issues, the program operable to perform the steps of:
storing a project on a centralized database;
adding an issue associated with the project to the centralized database; and
enabling users to add at least one step taken to resolve the issue to the centralized database;
providing an option to a user to upload a data file which is in a data format which the user determines would be inefficient to convert to the standardized format.

31. The computer readable medium of claim 30, the program further operable to perform the steps of:
closing the issue upon resolution.

32. The computer readable medium of claim 31, wherein the issue is closed after a responsible user sends a request to close the issue to a system administrator associated with the database.

33. The computer readable medium of claim 30, the program further operable to perform the steps of:
adding an issue description to the centralized database.

34. The computer readable medium of claim 33, wherein the issue description includes a status, a priority rating, and a sponsor.

35. The computer readable medium of claim 30, the program further operable to perform the steps of:
adding a step description to the centralized database.

36. The computer readable medium of claim 30, the program further operable to perform the steps of:
receiving a request from a user for the issue and said at least one step; and
providing the issue and said at least one step to a user.

37. The computer readable medium of claim 36, wherein the issue and said at least one step are provided using hypertext transfer protocol via a network.

38. The computer readable medium of claim 36, the program further operable to perform the steps of:
receiving a request from the user for all issues related to the project; and
providing all issues associated with the project.

39. The computer readable medium of claim 38, the program further operable to perform the steps of:
providing all issues associated with a project in a user sortable format based on an issue number associated with each issue, a status associated with each issue, a priority rating associated with each issue, a classification associated with each issue, and a sponsor associated with each issue.

40. The computer readable medium of claim 30, the program further operable to perform the steps of:
receiving a request from a user to add a step to an issue;
adding the step to the centralized database; and
linking the step to the issue in the centralized database.

41. The computer readable medium of claim 40, the program further operable to perform the steps of:
storing a list comprising a plurality of responsible users for a project.

42. The computer readable medium of claim 41, the program further operable to perform the steps of:
notifying the plurality of responsible users when an issue has been updated or closed.
